(19) United States
(12) Patent Application Publication
(10) Pub. No.: US 2019/0258653 A1
(43) Pub. Date: Aug. 22, 2019

(54) SYSTEM OF DYNAMIC HIERARCHIES BASED ON A SEARCHABLE ENTITY MODEL

(71) Applicant: Honeywell International Inc., Morris Plains, NJ (US)

(72) Inventors: Blake Puhak, Morris Plains, NJ (US); John Sublett, Richmond, VA (US); Andrew Saunders, Richmond, VA (US)

(21) Appl. No.: 16/402,407

(22) Filed: May 3, 2019

Related U.S. Application Data
(63) Continuation of application No. 14/697,604, filed on Apr. 27, 2015.

(51) Int. Cl. G06F 16/28; G06F 16/26

(52) U.S. Cl. CPC G06F 16/288; F24F 11/62; G06F 16/26

(57) ABSTRACT

A system having dynamic hierarchies based on a searchable entity model. The present system may be used for defining hierarchies by defining each level based on the attributes of its objects. The multiple level structure may be specified according to level definitions, each one defining a mechanism for determining the members in an instantiation of the actual system hierarchy. Level definitions may incorporate lists, queries based on semantic tags and relationships, groupings based on semantic tags, and traversal of relationships. A feature may be that multiple hierarchies can be defined and the hierarchies can be updated automatically as the system is modified and objects are added, removed, or modified.

This application is a continuation of U.S. patent application Ser. No. 14/697,604, filed Apr. 27, 2015. U.S. patent application Ser. No. 14/697,604, filed Apr. 27, 2015, is hereby incorporated by reference.

### BACKGROUND

The present disclosure pertains to systems and management of systems and their components.

### SUMMARY

The disclosure reveals a system having dynamic hierarchies based on a searchable entity model. The system may be used for defining hierarchies by defining each level based on the attributes of its objects. The multiple level structure may be specified according to level definitions, each one defining a mechanism for determining the members in an instantiation of the actual system hierarchy. Level definitions may incorporate lists, queries based on semantic tags and relationships, groupings based on semantic tags, and traversal of relationships. A feature may be that multiple hierarchies can be defined and the hierarchies can be updated automatically as the system is modified and objects are added, removed, or modified.

### BRIEF DESCRIPTION OF THE DRAWING

FIG. 1 is a diagram of a collection of objects that may be regarded as a physical device or a representation of a physical device;

FIG. 2 is a diagram of a hierarchy definition in a symbol structured as rules in a context of relations among the objects in the diagram of FIG. 1;

FIG. 3 is a diagram of a resulting hierarchy based on the hierarchy definition of FIG. 2 and the objects in the diagram of FIG. 1;

FIG. 4 is a diagram of a hierarchy definition in a symbol structured as rules in a context of values among the objects in the diagram of FIG. 1;

FIG. 5 is a another resulting hierarchy based on the hierarchy definition of FIG. 4 and the objects in the diagram of FIG. 1;

FIG. 6a and FIG. 6b are diagrams that represent a collection of objects in a building control system that defines attributes and relations among them;

FIG. 7 is a diagram illustrating a definition of billing hierarchy;

FIG. 8 is a diagram of a billing hierarchy;

FIG. 9 is a diagram of a definition of a maintenance hierarchy;

FIG. 10 is a diagram of a maintenance hierarchy; and

FIG. 11 is a diagram of a definition of an alternate maintenance hierarchy; and

FIG. 12 is a diagram of an alternate maintenance hierarchy.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

Systems of devices appear to be growing increasingly complex. A single system may have a large number of devices, a large number of users, a large number of applications, and complex relationships among them. Different users and applications may have a need to see the same devices and data organized differently. As systems grow, it appears tedious, time consuming, and error prone to manually create multiple hierarchies for the same collection of devices and data.

Rather than requiring all system hierarchies to be defined from the root down to leaf nodes, the present mechanism may be used for defining hierarchies by defining each level based on the attributes of its objects. The multiple level structure may be specified according to level definitions, each one defining the mechanism for determining the members in the instantiation of the actual system hierarchy. Level definitions may incorporate lists, queries based on semantic tags and relationships, groupings based on semantic tags, and traversal of relationships. A feature may be that multiple hierarchies can be defined and the hierarchies can be updated automatically as the system is modified and objects are added, removed, or modified.

The present mechanism may be implemented in the Niagara™ 4 data model and tools. Traditionally, the Niagara Workbench has referred to the Niagara “thick client” Java user interface (UI) application and the version of it that runs inside of the Java Applet in a web browser. However, in Niagara 4, the non-Java Applet web browser interface (referred to as the Bajaux or ShellHxProfile interface) has been enhanced so that it includes a navigation tree similar to that in the Niagara 4. Workbench application. In the Bajaux/ShellHxProfile web application, one may also define hierarchies and navigate the resulting hierarchies.

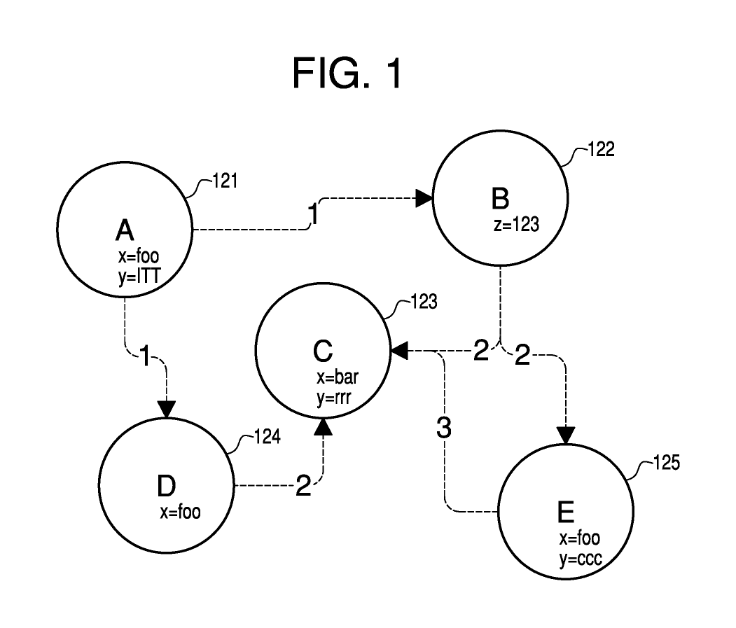

FIGS. 1-5 are diagrams showing how hierarchies may take a collection of objects and model them in different ways based on a set of rules. FIG. 1 is a diagram of a collection of objects that may be regarded as a physical device or a representation of a physical device. Object 121 may have values x=foo and y=rrr. Object 122 may have a value z=123. Object 123 may have a value of x=bar and y=rrr. Object 124 may have a value x=foo. Object 125 may have a value x=foo and y=ccc. Object 121 may have an outbound relation 1 with object 122. Object 121 may have an outbound relation 1 with object 124. Object 122 may have an outbound relation 2 with object 123 and object 125. Object 124 may have an outbound relation 2 with object 123. Object 125 may have an outbound relation 3 with object 123. If the relation between two objects is outbound in a direction from a first object to a second object, then the relation may be regarded as inbound from the second object to the first object.

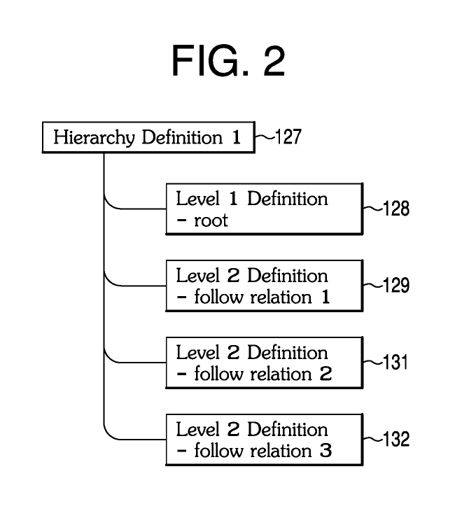

FIG. 2 is a diagram of a hierarchy definition 1 in a symbol 127 structured as rules in a context of relations among the objects in the diagram of FIG. 1. The definition may reveal a connection to a Level 1 Definition—root in symbol 128, Level 2 Definition—follow relation 1 in symbol 129, Level 2 Definition—follow relation 2 in symbol 131, and Level 2 Definition—follow relation 3 in symbol 132.

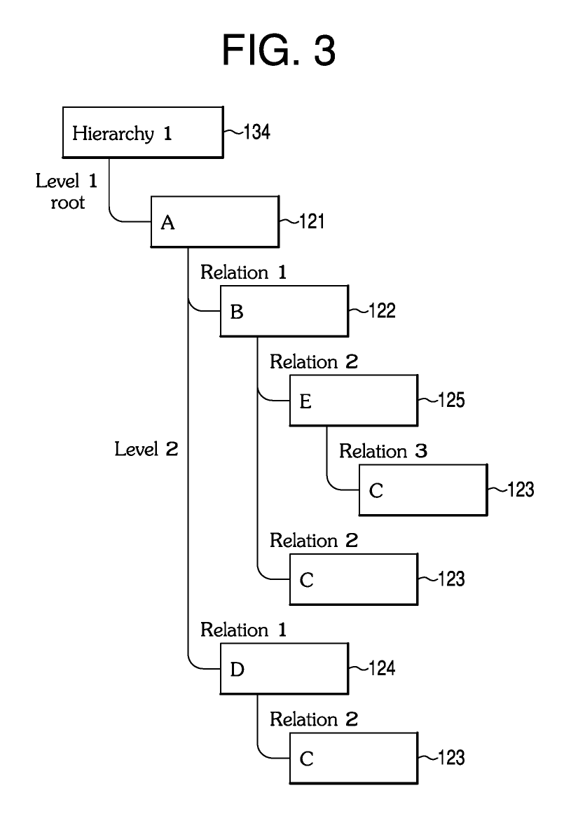

FIG. 3 is a diagram of a resulting hierarchy 1 labeled in symbol 134 based on the hierarchy definition of FIG. 2 and the objects 121-125 in the diagram of FIG. 1. Labels of levels 1 and 2 the relations 1-3 are indicated in FIG. 3.

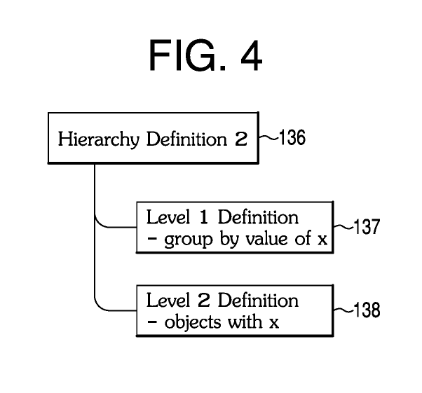

FIG. 4 is a diagram of a hierarchy definition 2 in a symbol 136 structured as rules in a context of values among the objects in the diagram of FIG. 1. Level 1 Definition—group by value x in symbol 137 and Level 2 Definition—objects with x in symbol 138 are shown.

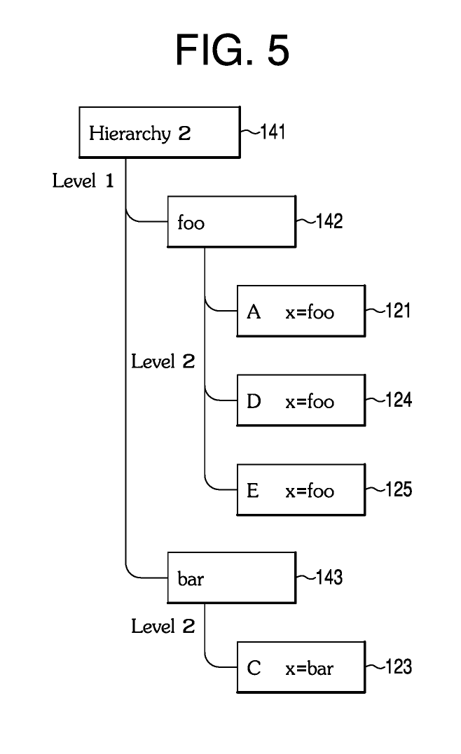

FIG. 5 is a resulting hierarchy 2 labeled in symbol 141 based on the hierarchy definition of FIG. 4 and the objects 121-125 in the diagram of FIG. 1. Labels of levels 1 and 2 for the values of x are indicated in FIG. 5. In symbol 142, x value of foo may be is noted relative to objects 121, 124 and 125. In symbol 143, an x value of bar may be noted relative to object 123.

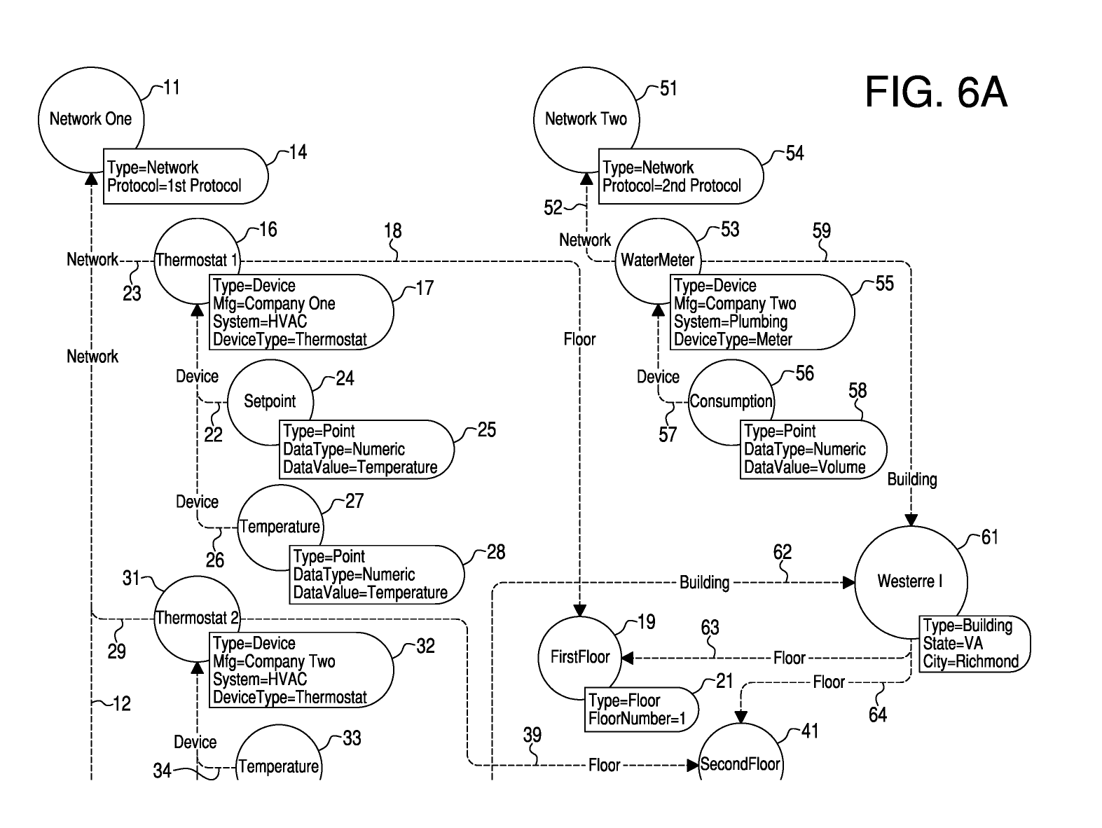

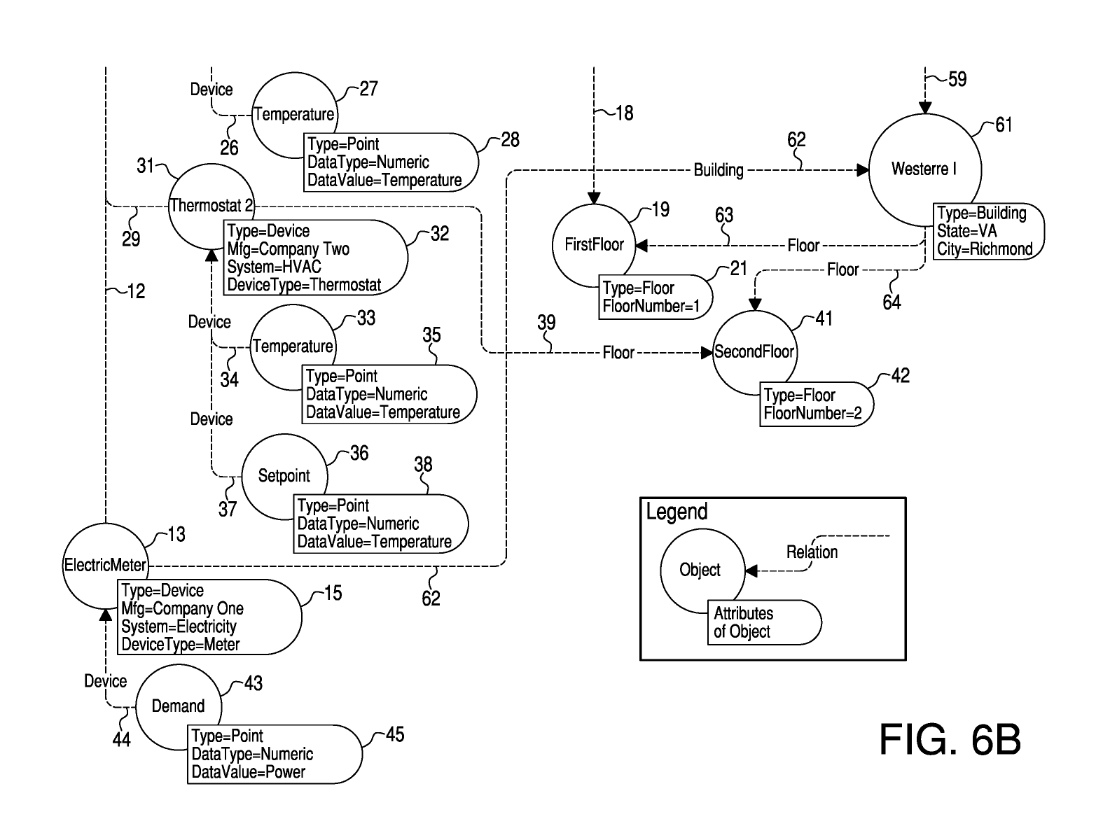

One may note a hierarchy example. FIG. 6a and FIG. 6b are diagrams that represent a collection of objects in a building control system that defines attributes and relations among them. In the Niagara Framework, these attributes or metadata may be called tags. Each object may have zero, one, or more tags and each tag may be made up of a name and an optional value (virtually all tags in this example happen to have values). The relations between components may have names, directions and tags. A direction of a relation appears important, and in legend 145 of the FIG. 6b, one may say that a relation is inbound to the object shown (if the object on the other side of the relation were shown, the relation would be outbound with respect to that object). An object may have zero, one, or more relations and can have multiple relations of the same name in the same or opposite directions. For clarity, in the above example, virtually all of the relations may be represented in another direction as well. For example, the device relation from demand to electric meter might instead be represented as a point relation from electric meter to demand. A typical system may have one or both of these relations defined. One may note that some objects in the collection do not necessarily appear in any of the hierarchies defined herein. Some objects appear in multiple hierarchies and in some configurations it may be possible for a given object to appear multiple times in a defined hierarchy. Additionally, when applied to users, a user may have access to view zero, one or more hierarchies in a given system.

The objects in the diagrams of FIG. 6a and FIG. 6b may be physical devices or software representations of devices, components or modules. The objects may have attributes and relations. The attributes may have names and values. The relations may have names and directions.

Object 11 may be a network one. Attributes 14 of object 11 may incorporate a type and protocol. The type may be a network and the protocol may be a 1st protocol, such as for example, BACnet™. Object 11 may have a relation 12 that is regarded as a network and is at an incoming direction from an object 13 which may be an electric meter. Attributes 15 of object 13 may be of a type, manufacturer, system and device type which are a device, Company One, electric and meter, respectively.

There may be a connection from an object 16, a thermostat, to object 11 via a relation 12 of a network. Attributes 17 of objects 16 may incorporate a type, manufacturer, system and device type that are for example a device, Company One, HVAC and thermostat, respectively. Object 16 may have a relation 18, such as a floor in a direction from object 16 to an object 19, which is for example a first floor. Object 19 may have attributes 21 of a type and floor number that are a floor and one, respectively, as examples.

Object 16 may have a relation 22 with an object 24 that is for example a setpoint. Attributes 25 of object 24 may incorporate a type, data type and data value of, for example, a point, numeric and temperature, respectively. Relation 22 may be that of a device having a direction from object 24 to object 16. Object 16 may also have a relation 26 with an object 27 that is for example a temperature. Object 27 may have attributes 28 that incorporate type, data type and data value of, for instance, point, numeric and temperature. Relation 26 may be that of a device having a direction from object 27 to object 16.

Object 16 may have a relation 29 with an object 31 that is for example a second thermostat. Relation 29 may be that of a network having a direction from object 31 to object 11. Object 31 may have attributes 32 of type, manufacturer, system and device type which are, for example, a device, Company Two, HVAC and a thermostat, respectively.

An object 33 may have a relation 34 with a direction to object 31. Object 33 and relation 34 may be, for instance, temperature and a device, respectively. Attributes 35 of object 33 may incorporate type, data type and data value, that are, for example, point, numeric and temperature, respectively.

An object 36 may have a relation 37 with a direction to object 31. Object 36 and relation 37 may be, for example, setpoint and device, respectively. Attributes 37 of object 36 may incorporate type, data type and data value that are, for instance, point, numeric and temperature, respectively.

Object 31 may have a relation 39 in a direction to an object 41. Relation 39 and object 41 may be a floor and a second floor, respectively. Object 41 may have attributes 42 incorporating type and floor number which are, for instance, floor and two, respectively.

An object 43 may have a relation 44 in a direction to object 13. Object 43 and relation 44 may, for example, be a demand and a device, respectively. Attributes 45 may incorporate type, data type and data value that, for instance, are point, numeric and power, respectively.

An object 51 may have an incoming relation 52 from an object 53. Object 51, relation 52 and object 53 are, for example, a network two, a network and a water meter, respectively. Object 51 may have attributes 54 that incorporate type and protocol. Type and protocol may be a network and a 2nd protocol, such as for example, Modbus™, respectively. Object 53 may have attributes 55 that incorporate type, manufacturer, system, and device type, which may be for instance, a device, Company Two, plumbing and device type, respectively.

An object 56 may have a relation 57 that goes in a direction out to object 53. Object 56 and relation 57 may be consumption and a device, respectively. Object 56 may have attributes 58 that incorporate type, data type and data value. Point, numeric and a volume may be instances of type, data type and data value.

A relation 59 may go from object 53 to an object 61. Relation 59 and object 61 may be, for example, a building and a Westerre I, respectively. Object 61 may have a relation 62 in a direction from object 13 to object 61. Relation 62 may be, for example, a building relation. A relation 63 may proceed from object 61 to object 19. A relation 64 may proceed from object 61 to object 41. Each of relations 63 and 64 may be, for instance, a floor relation. Object 61 may have attributes 65 that may incorporate type, state a city. Building, VA and Richmond may be instances of type, state and city, respectively.

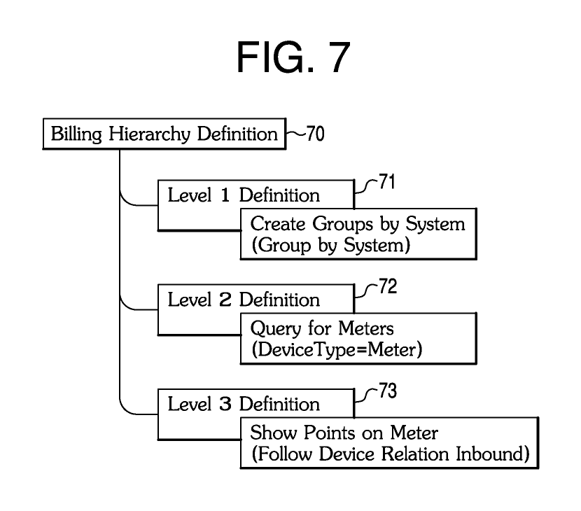

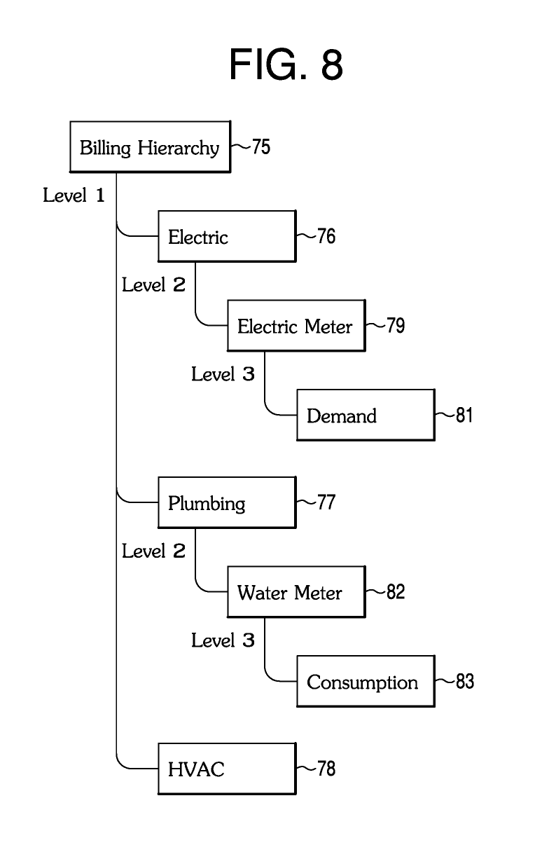

FIGS. 7-12 are diagrams of example hierarchy definitions and resulting hierarchies. FIGS. 7 and 8 are diagrams relating to hierarchy navigation for a user in finance department. FIG. 7 is a diagram illustrating a definition of billing hierarchy. The hierarchy definition may define three levels of navigation. The first level (Level 1) may create navigation groups based on the unique values of a system tag. Level 2 may display objects with the DeviceType=Meter tag that also have the system tag equal to the group that they appear under. The level 3 definition may define that objects on this navigation level are related to the meter on the above level that are device relations pointing at the meter. If the relations were defined in the opposite direction, this may be a point relation in an outbound direction.

FIG. 8 is a diagram of a billing hierarchy. When one applies the “Billing Hierarchy Definition” to a “Collection of Objects in a Building System,” one may get a billing hierarchy of the system. There may be two groups—one for each unique value of system. Under each group may be the devices that have a DeviceType=Meter and a system equal to the group that they are under. Each inbound device relation on each device/meter may then be followed to show the demand and consumption objects under their respective meters.

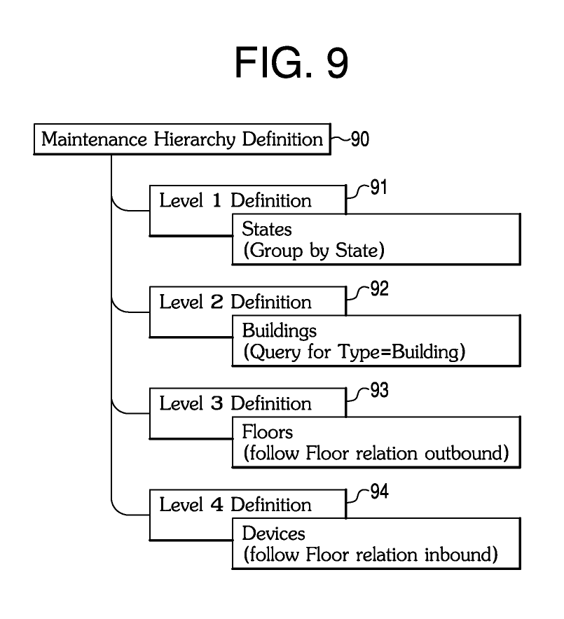

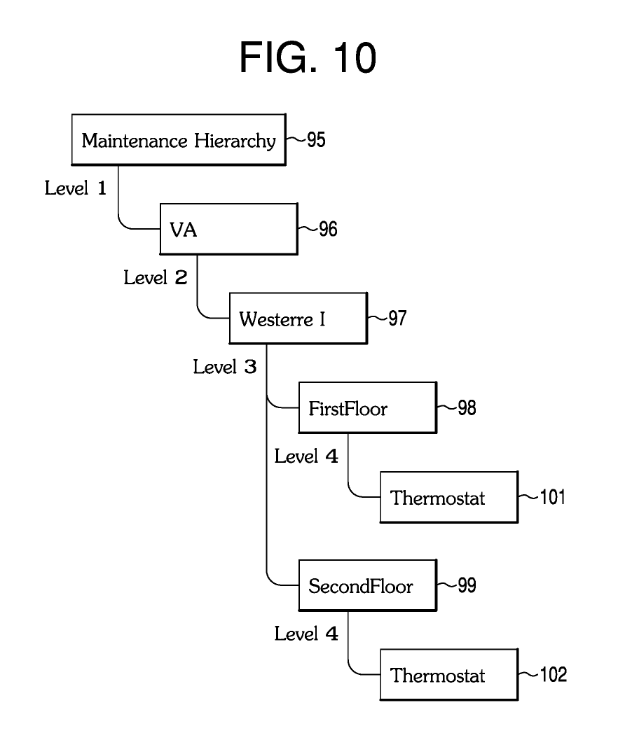

FIGS. 9 and 10 are diagrams showing hierarchy navigation for a user in building maintenance. FIG. 9 is a diagram of a definition of a maintenance hierarchy. FIG. 10 is a diagram of maintenance hierarchy which may be a result of applying the “Maintenance Hierarchy Definition” to the “Collection of Objects in a Building System.”

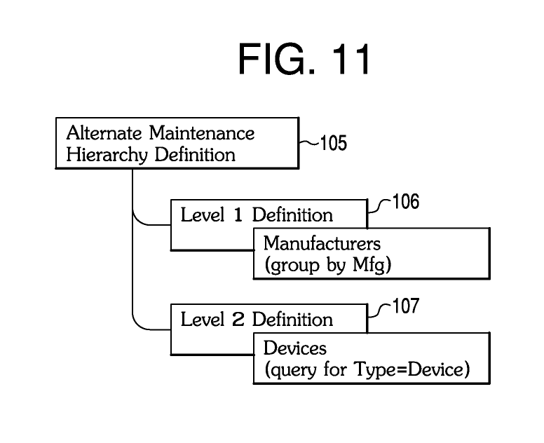

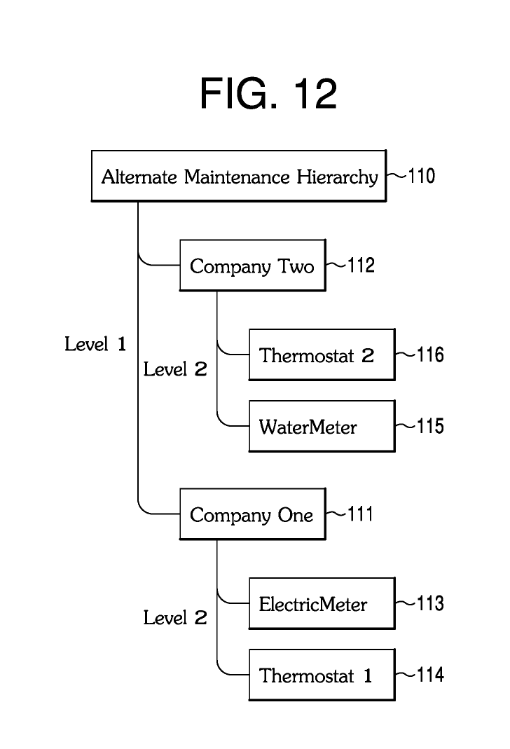

FIGS. 11 and 12 are diagrams of an alternate hierarchy for a user in building maintenance. FIG. 11 is a diagram of a definition of devices by an example maintenance hierarchy. FIG. 12 is a diagram of alternate maintenance hierarchy which may be a result of applying the “Alternate Maintenance Hierarchy Definition” to the “Collection of Objects in a Building System.”

FIGS. 7-12 may be noted in further detail. FIG. 7 is a diagram of a hierarchy definition 70 for billing as an example. A level 1 definition 71 may be a root in that one may create groups by system (group by system). A level 2 definition 72 may follow a relation that is a query for meters (device type=meter). A level 3 definition 73 may follow a relation that shows points on a meter (follow a device relation inbound).

FIG. 8 is a diagram of a resulting billing hierarchy 75 that has a relation to an object 76, object 77 and object 78, which may be electric, plumbing and HVAC, respectively. Object 76 may have a relation to an object 79 which may be an electric meter. Object 79 may have a relation relative to object 81 which may be a demand. Object 77 may have a relation to an object 82 that may be a water meter. Object 82 may have a relation to an object 83 that may be consumption.

FIG. 9 is a diagram to a hierarchy definition 90 for maintenance as an example. A level 1 definition 91 may be a root relative to states (group by state). A level 2 definition 92 may follow a relation for buildings (a query for type=building). A level 3 definition 93 may follow a relation for floors (follow a floor relation outbound). A level 4 definition 94 may follow a relation for devices (follow a floor relation inbound).

FIG. 10 is a diagram of a resulting maintenance hierarchy 95 that has a relation to an object 96 which may be, for example, a state of Virginia (VA). Object 96 may have a relation to an object 97 that may be, for example, a place of Westerre I. Object 97 may have a relation to an object 98 and object 99, which may be, for instance, a first floor and a second floor, respectively. Object 98 may have a relation to an object 101 that may be, for example, a thermostat 1. Object 99 may have a relation to an object 102 that may be, for example a thermostat 2.

FIG. 11 is a diagram to a hierarchy definition 105 for alternate maintenance as an example. A level 1 definition 106 may be a root relative to manufacturers (group by manufacturer). A level 2 definition may follow a relation for devices (a query for type=device).

FIG. 12 is a diagram of a resulting hierarchy 110 for alternate maintenance. Hierarchy 110 may have a relation to an object 111 which may be, for example, a Company One. Hierarchy 110 may also have a relation to an object 112 which may be, for example, a Company Two. Object 111 may have a relation to an object 113 that may be, for instance, a water meter. Object 111 may also have a relation to an object 114 that may be, for instance, a thermostat 1. Object 112 may have a relation to an object 115 that may be, for instance, a water meter. Object 112 may also have a relation to an object 116 that may be a thermostat 2.

To recap, a mechanism for developing one or more hierarchies may incorporate a collection of objects, a hierarchy definition having n levels of definition and s criteria, and a hierarchy of the objects developed on a basis of the hierarchy definition applied to the collection of objects. An object may be a physical entity. A first level definition may classify objects by an s-a criterion. An n-m level definition may classify objects by an s-b criterion. An n level definition classifies objects by an s-c criterion. A criterion may be based on one or more terms selected from a group incorporating attributes and relations. The letters n, m, s, a, b, and c may be numbers, and m<=n, a<s, b<=s and c<=s.

The hierarchy of the objects may be developed on a processor that applies the hierarchy definition to the collection of objects.

The hierarchy definition may be developed from criteria of the collection of objects for subject matter selected from a group incorporating technologies, activities and structures relating to the objects.

The hierarchy definition may be applied to a system incorporating the collection of objects to develop a system hierarchy.

The hierarchy definition may be applied to a plurality of systems of a selected technology, activity or structure. A hierarchy of the plurality of systems may be developed from an application of the hierarchy definition to the plurality of systems of a selected technology, activity or structure.

The structure may incorporate buildings. The criteria for buildings may incorporate grouping by geographic location as a first level definition, querying for a type of building as a second level definition, following a floor relation outbound as a third level definition, and following a floor relation inbound as a fourth level definition. A user may search a resulting hierarchy of buildings to drill down, scope in, discover or study an issue in buildings at a particular geographic location.

A hierarchy definition may be developed from a group incorporating general information, maintenance, evaluations, appraisals, and billings of the collection of objects.

A user may navigate a hierarchy in a displayed navigation sidebar of a workbench on a computer.

An approach for obtaining searchable hierarchies may incorporate selecting a collection of objects in a system, defining a hierarchy definition for the collection of objects according to a structure having one or more levels of definition, and applying the hierarchy definition to the collection of objects to obtain a system hierarchy. One or more definitions of each of the one or more levels of definitions may be based on attributes or relations of the objects. Each definition may determine members for an instantiation of an actual system hierarchy. An object may be a physical entity.

The selecting or defining may be performed by a processor.

Each definition of the one or more definitions may have a description that is different from other definitions of the same level.

A level of definition of the hierarchy definition may be rules definable by a user. The rules may be grouped by a criterion. The criterion selected may depend on an application of the rules.

Multiple hierarchy definitions may be determined. The hierarchy definitions may be updated automatically as the system is modified and the collection of objects has objects added, removed or modified.

The hierarchy definition may incorporate one or more levels of definition. The one or more levels of definition may specify one or more relations to follow and/or group objects by a value of an attribute, and select objects having a certain attribute or relation to follow.

The one or more definitions of each of the one or more levels may be further or instead be based on one or more items selected from a group incorporating lists, queries based on semantic tags, queries based on relationships, groupings based on semantic tags, and traversal of relationships.

An attribute may be anything that can be a basis of classification. A relation may be anything that pertains to ownership, parent-child relationship, building to floor relationship, or an object to object relationship.

A system of searchable hierarchies may incorporate a collection of objects, a hierarchy definition, and a hierarchy. The object may be a physical entity. The hierarchy definition may incorporate multiple levels of definitions. Multiple levels of definition may define a mechanism for determining members in an instantiation of a system hierarchy. Each level of definition may incorporate one or more definitions where each definition may have a description that is different from the descriptions of the other definitions of the same level.

The hierarchies may be in multiples for a system.

A user may search one or more hierarchies of interest or by permission.

The hierarchies may be defined and updated automatically as a system is modified and objects are added, removed and modified.

Each object of the collection of objects may have zero, one, or more attributes (tags).

Each relation between objects may incorporate a name, direction, and zero, one, or more attributes. Each attribute may incorporate a name and a value.

One or more descriptions of one level may be based on one or more items selected from a group incorporating attributes, lists, queries based on semantic tags, queries based on relationships, groupings based on semantic tags, and traversal of relationships.

Any publication or patent document noted herein is hereby incorporated by reference to the same extent as if each individual publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A set of searchable dynamic hierarchies comprising:
two or more searchable dynamic hierarchies defined on one or more collections of physical objects of a system; and
wherein:
each searchable dynamic hierarchy definition of the two or more searchable dynamic hierarchies comprises multiple levels of definition;
each searchable dynamic hierarchy of the two or more searchable dynamic hierarchies defines a mechanism for determining members in an instantiation of a searchable dynamic system hierarchy as applied to one collection of physical objects of a plurality of collections of physical objects;
each level of definition of a searchable dynamic hierarchy comprises one or more searchable dynamic hierarchy definitions based upon attributes of physical objects of one or more collections of physical objects;
each searchable dynamic hierarchy definition of a level of a searchable dynamic hierarchy is different from each remaining searchable dynamic hierarchy definitions of the same level; and
each physical object of each of the one or more collections of physical objects can have as an attribute multiple relations of the same name in the same or opposite directions.

2. The set of searchable dynamic hierarchies of claim 1, wherein a user can search one or more searchable dynamic hierarchies of interest or by permission.

3. The set of searchable dynamic hierarchies of claim 1, wherein the two or more searchable dynamic hierarchies are defined and updated automatically as a physical object of the one or more collections of physical objects is modified and physical objects are added, removed, or modified.

4. The set of searchable dynamic hierarchies of claim 1, wherein each physical object of the one or more collections of physical objects has zero, one, or more attributes and each relation between physical objects comprises a name, direction, and zero, one, or more attributes and each attribute comprises a name and a value.

5. The set of searchable dynamic hierarchies of claim 1, wherein one or more searchable dynamic descriptions of one level are based on one or more items selected from the group consisting of attributes, lists, queries based on semantic tags, queries based on relationships, groupings based on semantic tags, and traversal of relationships.

6. The set of searchable dynamic hierarchies of claim 1, wherein each searchable dynamic hierarchy of the two or more searchable dynamic hierarchies defines a mechanism for determining members in an instantiation of a searchable dynamic system hierarchy as applied to another collection of the one or more collections of physical objects.

7. The set of searchable dynamic hierarchies of claim 1, wherein a searchable dynamic hierarchy definition of multiple searchable dynamic hierarchy definitions comprises applying in order a first level definition through an n^{th} level definition to attributes of one collection of physical objects.

8. The set of searchable dynamic hierarchies of claim 7, wherein each of the first level definition through the n^{th} level definition classifies objects by a criterion applied to the attributes of one collection of physical objects.

9. The set of searchable dynamic hierarchies of claim 8, wherein a criterion is based on one or more terms selected from the group consisting of attributes and relations having a name and a direction.

10. A method for defining a set of searchable dynamic hierarchies comprising:
selecting a collection of physical objects in a system, each physical object comprising attributes;
defining multiple searchable dynamic hierarchies for the collection of physical objects according to an ordered structure having multiple levels of definition; and
applying multiple searchable dynamic hierarchy definitions to the collection of physical objects to obtain a system hierarchy; and
wherein:
one or more levels of a dynamic hierarchy definition of multiple searchable dynamic hierarchy definitions based on attributes or relations of the collection of physical objects are applied in order;
each physical object can have multiple relations of the same name in the same or opposite directions; and
each definition determines members for an instantiation of a system hierarchy.

11. The method of claim 10, wherein each searchable dynamic hierarchy definition of the multiple searchable dynamic hierarchy definitions has a description that is different from other definitions of the same level.

12. The method of claim 10, wherein:
a level of a searchable dynamic hierarchy definition of the multiple searchable dynamic hierarchy definitions includes rules definable by a user; and
the rules are grouped by a criterion and the criterion selected depends on an application of the rules.

13. The method of claim 10, wherein:
multiple searchable dynamic hierarchy definitions are defined; and
the multiple searchable dynamic hierarchies are updated as the system is modified and the collection of physical objects has physical objects added, removed, or modified.

14. The method of claim 10, wherein:
each searchable dynamic hierarchy definition of the multiple searchable dynamic hierarchy definitions comprises one or more levels of definition; and
the one or more levels of definition specify one or more relations to follow and/or group objects by a value of an attribute, and select objects having a certain attribute or relation to follow.

15. The method of claim 14, wherein:
an attribute is anything that can be a basis of classification; and
a relation is anything that pertains to an ownership, a parent-child relationship, a building to floor relationship, or an object to object relationship.

16. The method of claim 10, wherein the one or more searchable dynamic hierarchy definitions of each of the one or more levels are further or instead based on one or more items selected from the group consisting of lists, queries based on semantic tags, queries based on relationships, groupings based on semantic tags, and traversal of relationships.

17. The method of claim 10, wherein a collection of physical objects in a system may be replaced by a different collection of physical objects in the system by adding or removing physical objects.
